(19) United States
(12) Patent Application Publication
(10) Pub. No.: US 2025/0058679 A1
(43) Pub. Date: Feb. 20, 2025

(54) ACTUATOR WITH ROTATABLE PUSH STRUCTURE

(71) Applicant: Toyota Motor Engineering & Manufacturing North America, Inc., Plano, TX (US)

(72) Inventors: Brian J. Pinkelman, Ann Arbor, MI (US); Frederick William Mau, II, Mckinney, TX (US); Michael Paul Rowe, Pinckney, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/452,343

(22) Filed: Aug. 18, 2023

(51) Int. Cl. B60N 2/02

(52) U.S. Cl. CPC B60N 2/026

(57) ABSTRACT

An actuator is configured to provide an enhanced haptic or massaging sensation to a user. The actuator can include an outer body member. The actuator can include a push structure operatively connected to the outer body member. The push structure can be configured to rotate. When activated, the actuator can be configured to morph into an activated configuration in which a dimension of the actuator increases and such that a position of the push structure changes.

### FIELD

The subject matter described herein relates in general to actuators and, more particularly, to actuators that provide a haptic effect.

### BACKGROUND

A vehicle typically includes a plurality of seats. There are numerous vehicle seat designs. Vehicles seats can be contoured and/or can include features to provide support and comfort to a vehicle occupant. Some vehicle seats can include various ergonomic features to enhance user comfort. Some vehicle seats are powered and allow a user to adjust one or more aspects of the seat. Some vehicle seats can provide a massaging effect to a user.

### SUMMARY

In one respect, the present disclosure is directed to an actuator. The actuator can include an outer body member. The actuator can include a push structure operatively connected to the outer body member. The push structure can be configured to rotate. When activated, the actuator can be configured to morph into an activated configuration in which a dimension of the actuator increases and such that a position of the push structure changes.

In another respect, the present disclosure is directed to a method for an actuator. The actuator can include an outer body member. The actuator can include a push structure operatively connected to the outer body member. The push structure can be configured to rotate. The method can include causing the actuator to morph into an activated configuration in which a dimension of the actuator increases and such that a position of the push structure changes. The method can further include causing the push structure to rotate.

### BRIEF DESCRIPTION OF THE DRAWINGS

FIG. 1 is a cross-sectional view of an example of an actuator, showing a non-activated configuration.

FIG. 2 is a cross-sectional view of the actuator of FIG. 1, showing an activated configuration.

FIG. 3 is an example of a push structure in an initial position.

FIG. 4 is an example of the push structure in a rotated position.

FIG. 5A is a first example of an actuator with a push structure configured for rotation.

FIG. 5B is a second example of an actuator with a push structure configured for rotation.

FIG. 5C is a third example of an actuator with a push structure configured for rotation.

FIG. 5D is a fourth example of an actuator with a push structure configured for rotation.

FIG. 5E is a fifth example of an actuator with a push structure configured for rotation.

FIG. 6 is an example of a system for an actuator with a rotatable push structure.

FIG. 7 is an example of a method of actuating an actuator with a rotatable push structure.

### DETAILED DESCRIPTION

Vehicle seats that provide a haptic effect, such as massaging, typically do not offer much flexibility in the haptic output. Accordingly, arrangements described herein are directed to, among other things, an actuator. The actuator can include a push structure. When activated, the actuator can be configured to morph into an activated configuration in which a dimension of the actuator increases and such that a position of the push structure changes. The push structure can be configured to rotate, simultaneously with and/or subsequently to the morphing of the actuator. Thus, in additional to the effect of the pushing effect of the push structure, the actuator can provide a turning sensation through the rotational movement of the push structure. As a result, an enhanced haptic effect and/or enhanced massaging can be provided by the actuator.

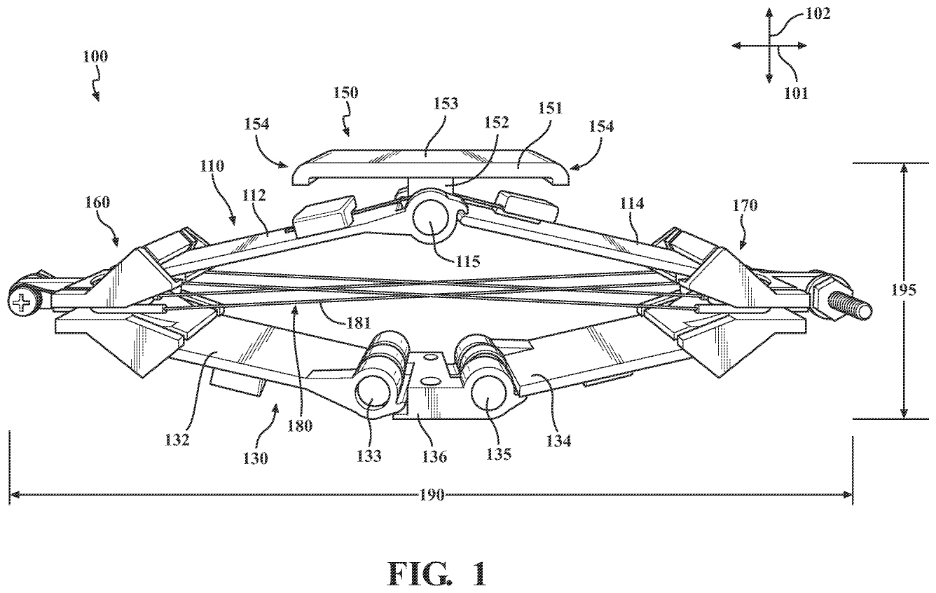

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

Arrangements described herein are directed to an actuator. The actuator can be any suitable type of actuator, now known or later developed. Therefore, it will be understood that the examples described herein are not intended to be limiting.

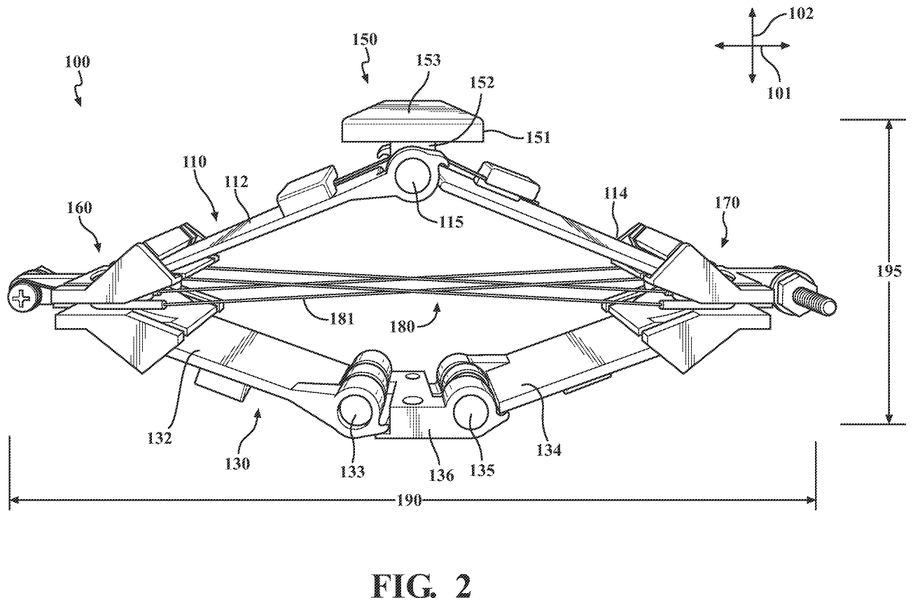

Referring to FIGS. 1 and 2, an example of an actuator 100 suitable for use according to arrangements herein. The basic details of the actuator 100 will now be described. Additional details of the actuator 100 are described in U.S. patent application Ser. No. 18/329,217, which is incorporated herein by reference.

The actuator 100 can include a first outer body member 110, a second outer body member 130, a first endcap 160, a second endcap 170, and a contracting member180. The first endcap 160 and the second endcap 170 can be spaced apart in a first direction 101. The first outer body member 110 and the second outer body member 130 can be spaced apart in a second direction 102.

The first outer body member 110 can include a first portion 112 and a second portion 114. The first portion 112 and the second portion 114 can be operatively connected to each other such that the first portion 112 and the second portion 114 can move relative to each other. In one or more arrangements, the first portion 112 and the second portion 114 can be pivotably connected to each other. For example, the first portion 112 and the second portion 114 can be pivotably connected to each other by one or more hinges 115. The first portion 112 and the second portion 114 can be angled relative to each other. As a result, the first outer body member 110 can have a generally V-shape.

The second outer body member 130 can include a first portion 132, a second portion 134, and a base 136. In one or more arrangements, each of the first portion 132 and the second portion 134 can be pivotably connected to the base 136. For example, the first portion 132 can be pivotably connected to the base 136 by one or more hinges 133, and the second portion 134 can be pivotably connected to the base 136 by one or more hinges 135. The first portion 132 and the second portion 134 can be located on opposite sides of the base 136.

As noted above, the actuator 100 can include a first endcap 160 and a second endcap 170. The first endcap 160 and the second endcap 170 can have any suitable size, shape, and/or configuration. In one or more arrangements, the first endcap 160 and the second endcap 170 can be substantially identical to each other. In one or more arrangements, the first endcap 160 and the second endcap 170 can be different from each other in one or more respect.

The actuator 100 can include one or more contracting members 180. The contracting member(s) 180 can be any structure that, when activated, is configured to shrink in length. In one or more arrangements, the contracting member(s) 180 can be one or more shape memory material members 181. The shape memory material member(s) 181 can extend between the first endcap 160 and the second endcap 170 in any suitable manner. The shape memory material member(s) 181 can be operatively connected to the first endcap 160 and the second endcap 170. Any suitable manner of operative connection can be provided, such as one or more fasteners, one or more adhesives, one or more welds, one or more brazes, one or more forms of mechanical engagement, or any combination thereof.

In some arrangements, there can be a single shape memory material member 181. In such case, the shape memory material member 181 can, for example, extend straight across the cavity from the first endcap 160 and the second endcap 170. In another example, the shape memory material member 181 can extend in a serpentine pattern between the first endcap 160 and the second endcap 170. In some arrangements, the first endcap 160 and the second endcap 170 can be configured to allow the shape memory material member 181 to turn around and extend in the opposite direction, as described above.

In some arrangements, there can be a plurality of shape memory material members 181. In such case, the plurality of shape memory material members 181 can be distributed, arranged, and/or oriented in any suitable manner. For instance, the shape memory material members 181 can extend substantially parallel to each other. In other arrangements, one or more of the shape memory material members 181 can extend non-parallel to the other shape memory material members 181. In some instances, some of the plurality of shape memory material members 181 may cross over each other.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members 181 can be shape memory material wires. As an example, the shape memory material members 181 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N mm, or greater than about 500 N mm, where the unit of newton millimeter (N mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members 181 to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material member(s) 181 are described, in some implementations, as being wires, it will be understood that the shape memory material member(s) 181 are not limited to being wires. Indeed, it is envisioned that suitable shape memory materials may be employed in a variety of other forms, such as sheets, plates, panels, strips, cables, tubes, or combinations thereof. In some arrangements, the shape memory material member(s) 181 may include an insulating coating or an insulating sleeve over at least a portion of their length.

It should be noted that the shape memory material member(s) 181 can be located substantially entirely within the overall envelope of the actuator 100. A portion of the shape memory material member(s) 181 can extend outside of a respective one of the endcaps 160, 170 for operative connection to another conductor and/or power source.

The actuator 100 can include a first dimension 190, which can correspond to the first direction 101. The actuator 100 can include a second dimension 195, which can correspond to the second direction 102. The first dimension 190 can describe a width of the actuator 100, and the second dimension195 can describe a height of the actuator 100. The first dimension 190 and the second dimension 195 can be substantially perpendicular to each other.

FIG. 1 shows an example of the actuator 100 in a non-activated configuration. Here, the shape memory material member(s) 181 are not activated. FIG. 2 shows an example of the actuator 100 in an activated configuration. When an activation input (e.g., electrical energy or other input that can change the temperature of the shape memory material member(s) 181) is provided to the shape memory material member(s) 181, the shape memory material member(s) 181 can contract. This contraction can cause the actuator 100 to morph into the activated configuration. More particularly, the contraction can cause the shape memory material member(s) 181 to pull the first endcap 160 and the second endcap 170 toward each other in the first direction 101. As a result, the first outer body member 110 and the second outer body member 130 can extend outward and away from each other in a direction that corresponds to the second direction 102. It will be appreciated that, in going from the non-activated condition to the activated condition, the first dimension 190 (i.e., the width) of the actuator 100 can decrease and/or the second dimension 195 (i.e., the height) of the actuator 100 can increase. Further, it will be appreciated that the actuator 100 can deliver a force in a direction that is out of plane or otherwise different from the direction of contraction of the shape memory material member(s) 181.

Again, the actuator 100 shown in FIGS. 1-2 is merely one example of a suitable actuator in accordance with arrangements described herein and is not intended to be limiting. Other actuators are described in U.S. patent Publication Nos. 17/729,522 and 18/329,217 as well as U.S. Pat. No. 10,960,793, which are incorporated herein by reference in their entireties. Further, it will be appreciated that arrangements described herein are not limited to actuators with contracting member(s) or shape memory material member(s).

The actuator 100 can include a push structure 150. The push structure 150 can be configured to engage other structures, surfaces, or objects. The push structure 150 can focus the force of the actuator 100 on an intended target object. The push structure 150 can have any suitable size, shape, and/or configuration. In one or more arrangements, the push structure 150 can be substantially T-shaped. In some arrangements, the push structure 150 can include a platform 151 and a stem 152. In some arrangements, the platform 151 can substantially be a rectangular prism, as is shown. In some instances, the platform 151 can have downturned ends 154, as shown. In some instances, the platform 151 can be a plate-like structure. In other arrangements, the platform 151 can be substantially cylindrical, substantially elliptical cylindrical, substantially triangular prismatic, substantially polygonal prismatic, substantially hexagonal prismatic, substantially octagonal prismatic, substantially trapezoidal prismatic, substantially barrel-shaped, or substantially half-barrel shaped, just to name a few possibilities.

The platform 151 can have an engaging surface 153. The engaging surface 153 can be configured to provide a desired actuation effect on an intended target. In some arrangements, the engaging surface 153 can be substantially planar. In some arrangements, the engaging surface 153 can include one or more contours, protrusions, steps, recesses, elements, or other raised or non-planar features. The engaging surface 153 can be configured to create a focal point for the push force of the actuator 100. In some arrangements, the engaging surface 153 can include textures to provide an additional sensation. In some arrangements, the engaging surface 153 can include at least partially embedded rollers or other features to provide an additional sensation.

The engaging surface 153 can have any suitable size, shape, and/or configuration. For instance, the engaging surface 153 can be substantially rectangular, substantially circular, substantially oval, substantially polygonal, substantially triangular, substantially hexagonal, substantially octagonal, or substantially trapezoidal, just to name a few possibilities.

In some arrangements, the engaging surface 153 can be substantially parallel to the shape memory material member(s) 181 and/or to the first direction 101 of the actuator 100. In some arrangements, the engaging surface 153 can be angled relative to the shape memory material member(s) 181 and/or to the first direction 101 of the actuator 100. The engaging surface 153 can have any suitable orientation to achieve a desired actuation force effect.

The push structure 150 can be operatively connected to the first outer body member 110. In some arrangements, the push structure 150 can be operatively connected to the first portion 112 and the second portion 114. While the first portion 112 and the second portion 114 can pivot relative to each other, the push structure 150 can substantially maintain its orientation. In some arrangements, the push structure 150 can be substantially centrally located on the first outer body member 110. However, in other arrangements, the push structure 150 can be offset from the center of the first outer body member 110. In some arrangements, the actuator 100 can be a plurality of push structures 150.

When the actuator 100 morphs into the activated configuration, the position of the push structure 150 can change. For instance, in the orientation of the actuator 100 shown in FIGS. 1-2, the push structure 150 move to a higher elevation when the actuator 100 morphs from the non-activated configuration to the activated configuration.

The push structure 150 can be configured to rotate. In some arrangements, the rotation of the push structure 150 can occur independently of the activation and/or deactivation of the actuator 100. In such case, the push structure 150 can rotate before, during, and/or after the morphing of the actuator 100 into the activated configuration and/or the non-activated configuration.

In other arrangements, the rotation of the push structure 150 can be dependent upon the activation and/or deactivation of the actuator 100. Thus, the push structure 150 can be configured to rotate when the actuator 100 is morphing into the activated configuration. Alternatively or additionally, the push structure 150 can be configured to rotate when the actuator 100 is returning to the non-activated condition.

In some arrangements, the push structure 150 can be configured to only rotate clockwise. In other arrangements, the push structure 150 can be configured to only rotate counterclockwise. In still other arrangements, the push structure 150 can be configured to rotate clockwise and counterclockwise. The push structure 150 can be configured to rotate at any suitable speed. In some arrangements, the speed can be adjusted by a manufacturer, user, or other entity.

The push structure 150 can be configured to rotate any suitable amount. For instance, the push structure 150 can be configured to make one or more full rotations about its axis 155. As another example, the push structure can be configured to rotate less than a full rotation about its axis 155, such as about 350 degrees or less, about 340 degrees or less, about 330 degrees or less, about 320 degrees or less, about 310 degrees or less, about 300 degrees or less, about 290 degrees or less, about 280 degrees or less, about 270 degrees or less, about 260 degrees or less, about 250 degrees or less, about 240 degrees or less, about 230 degrees or less, about 220 degrees or less, about 210 degrees or less, about 200 degrees or less, about 190 degrees or less, about 180 degrees or less, about 170 degrees or less, about 160 degrees or less, about 150 degrees or less, about 140 degrees or less, about 135 degrees or less, about 130 degrees or less, about 120 degrees or less, about 110 degrees or less, about 100 degrees or less, about 90 degrees or less, about 80 degrees or less, about 70 degrees or less, about 60 degrees or less, about 50 degrees or less, about 45 degrees or less, about 40 degrees or less, about 30 degrees or less, about 20 degrees or less, or about 10 degrees or less, just to name a few possibilities.

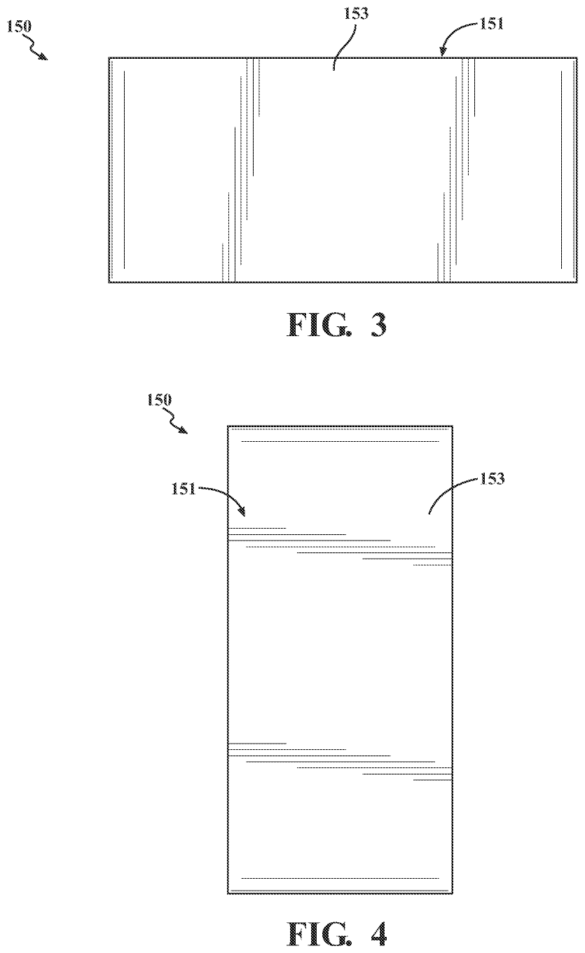

One example of the rotation of the push structure 150 is shown in FIGS. 3 and 4. FIG. 3 shows an initial position of the push structure 150. FIG. 4 shows the push structure 150 in a rotated position. In this example, the push structure 150 rotates clockwise from the initial position.

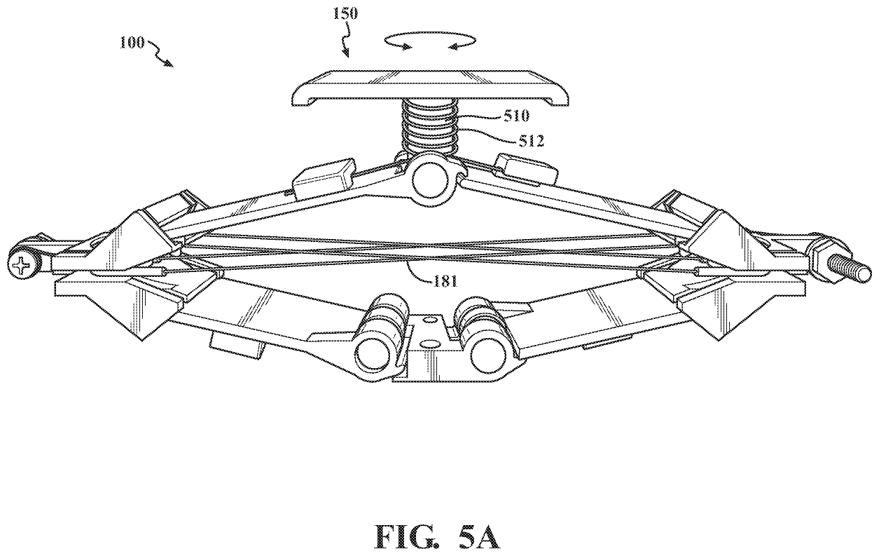

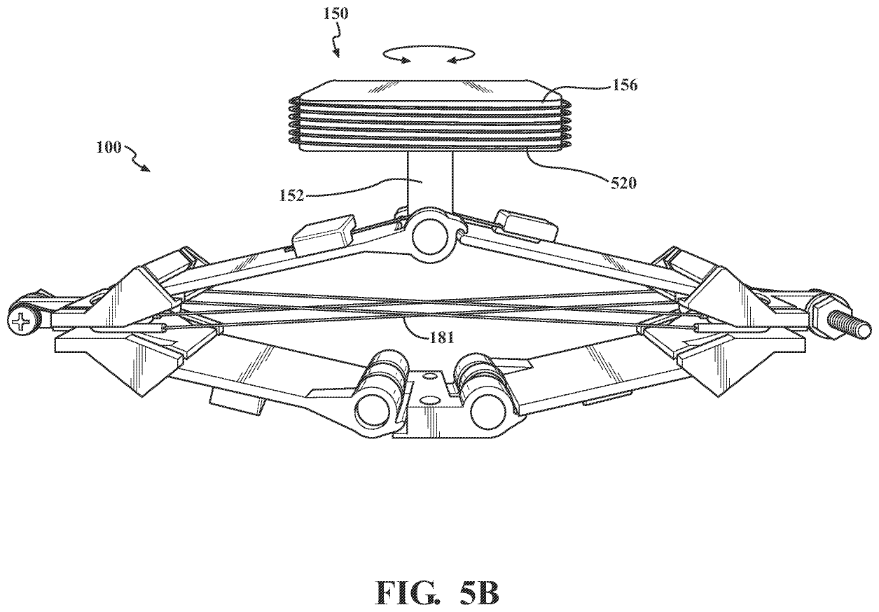

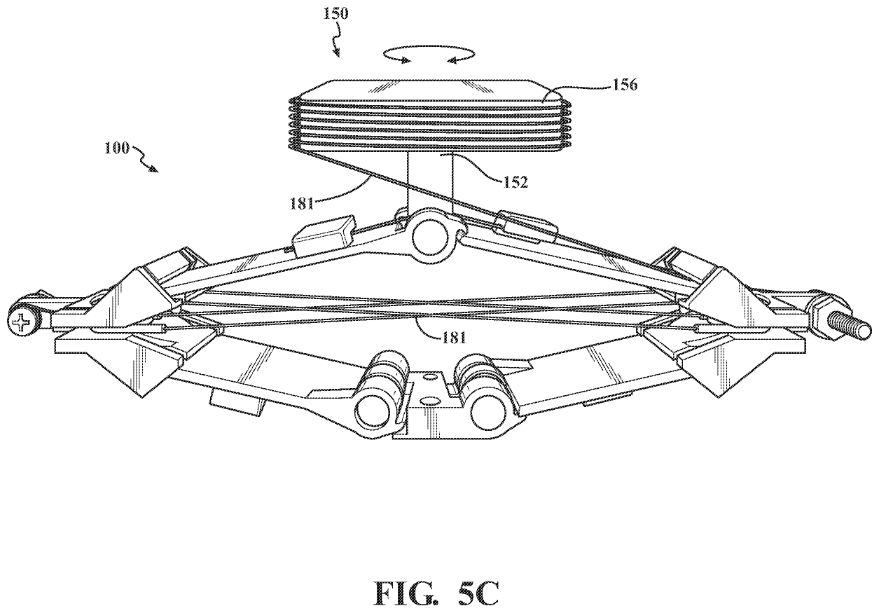

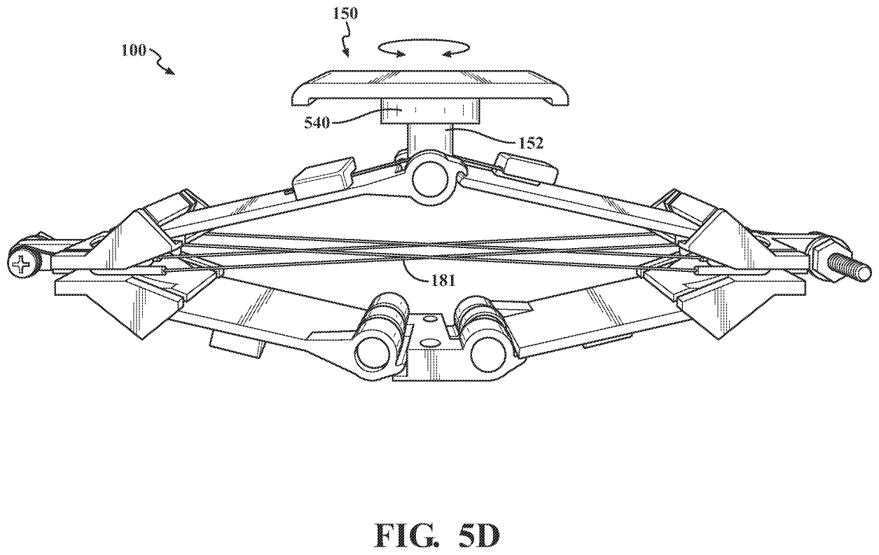

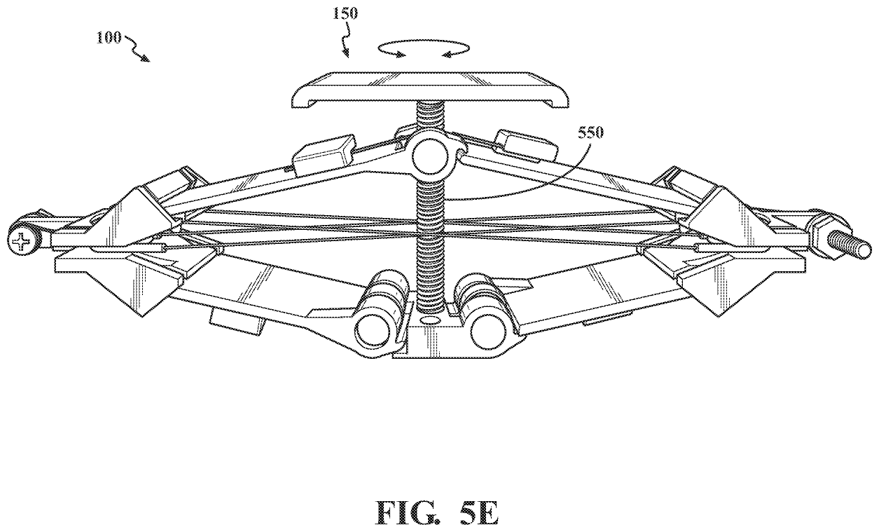

There are numerous ways in which the rotation of the push structure 150 can be achieved. FIGS. 5A-5E present non-limiting examples of various ways in which the push structure 150 can be configured to rotate. Each of these examples will be discussed in turn below.

FIG. 5A shows a first example of the actuator 100 with a push structure 150 configured for rotation. In this example, the stem 152 can be a shaft or spindle 510. The platform 151 of the push structure 150 can be operatively connected to the spindle 510. In some arrangements, the platform 151 can freely rotate on the spindle 510. A biasing element, such as a torsion spring 512, can be used to bias the platform 151 back to an initial position or to a pre-rotation position. In some arrangements, the torsion spring 512 can be wrapped around the spindle 510. The torsion spring 512 can be operatively connected to the push structure 150, to the spindle 510, some other structure, or any combination thereof.

In this example, the rotation of the platform 151 can be induced when the actuator 100 is activated and the platform 151 is push into contact with an object (e.g., a person). Alternatively or additionally, rotation of the platform 151 can also be induced by the movement of the push structure 150 when the actuator 100 morphs into a different configuration.

In an alternative arrangement, the platform 151 can be operatively connected to the spindle 510 so that the platform 151 does not rotate relative to the spindle 510. However, the spindle 510 can be operatively connected to the first outer body member 110 such that the spindle 510 can freely rotate on the first outer body member 110. The torsion spring 512 can bias the spindle 510 back to a pre-rotation position or a neutral position.

It will be appreciated that, in this arrangement, the rotation of the push structure 150 can occur independently of the morphing of the actuator 100. However, in some instances, the morphing of the actuator 100 can induce the rotation of the push structure 150. In such instances, the rotation of the push structure 150 can be dependent upon the morphing of the actuator 100.

FIG. 5B shows a second example of the actuator 100 with a push structure 150 configured for rotation. In this example, a shape memory material member 520 can be wrapped about an outer peripheral surface 156 of the platform 151. In some arrangements, the outer peripheral surface 156 can be smooth. For instance, the outer peripheral surface 156 can be substantially cylindrical, substantially oval, substantially rounded rectangular, or substantially rounded polygonal, just to name a few possibilities. In some arrangements, the platform 151 can be substantially barrel shaped.

In this example, the platform 151 can have a greater thickness (e.g., compared to the platform 151 of FIG. 1). The greater thickness can provide sufficient surface area around which the shape memory material member 520 can be wrapped. The shape memory material member 520 can be wrapped about the outer peripheral surface 156 one or more times. In the arrangements shown, the shape memory material member 520 can be wrapped about the outer peripheral surface 156 a plurality of times.

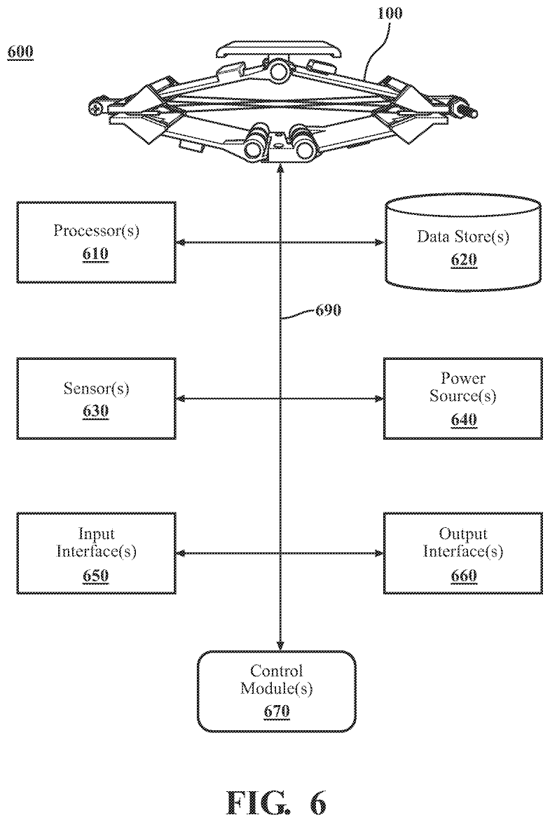

A first portion or end of the shape memory material member 520 can be operatively connected to the platform 151, such as to the outer peripheral surface 156. In some arrangements, a second portion or end of the shape memory material member 520 can be operatively connected to a power source (e.g., power source(s) 640 in FIG. 6). In some instances, the shape memory material member 520 can be operatively connected at one or more points to the outer peripheral surface 156 to help keep the shape memory material member 520 in place. Such operative connection can allow movement of the shape memory material member 520. For instance, the shape memory material member 520 can be operatively connected to the outer peripheral surface 156 by one or more hooks, clips, ties, clamps, loop clamps, routing clamps or wire fasteners.

When the shape memory material member 520 is activated, such as by supplying electrical energy to it (e.g., from the power source(s) 640 in FIG. 6) or in any other suitable manner, the shape memory material member 520 can contract. The contraction of the shape memory material member 520 can cause the rotation of the platform 151 and/or the stem 152. Thus, the contraction of the shape memory material member 520 can force the rotation of the platform 151 and/or the stem 152. It should be noted that the shape memory material member 520 is separate from the shape memory material member 181 used in the actuator 100. When the shape memory material member 520 is deactivated (e.g., by discontinuing the supply of electrical energy to it), the shape memory material member 520 can become relaxed. In some instances, the platform 151 and/or the stem 152 can remain in their rotated position when the shape memory material member 520 becomes relaxed. In other instances, the platform 151 and/or the stem 152 can be biased into their pre-rotation position.

It will be appreciated that, in this arrangement, the rotation of the push structure 150 can occur independently of the morphing of the actuator 100. As such, the push structure 150 can be rotated before, during, or after the morphing of the actuator 100.

Referring to FIG. 5C, a third example of an actuator with a push structure configured for rotation is shown. In this example, the shape memory material member wrapped about the outer peripheral surface 156 of the platform 151 is the shape memory material member 181 used in the actuator 100. Thus, a portion of the shape memory material member 181 extends from the actuator 100 to the platform 151. The above discussion in connection with FIG. 5B applied equally here.

It will be appreciated that, in this arrangement, the rotation of the push structure 150 can be dependent upon the morphing of the actuator 100. As such, the push structure 150 rotates simultaneously with the morphing of the actuator 100.

FIG. 5D shows a fourth example of an actuator with a push structure configured for rotation. In this arrangement, a motor 540 can be operatively connected to the platform 151. More particularly, the platform 151 can be operatively connected to an output shaft of the motor 540. Thus, the rotation of the output shaft can cause a rotation of the platform 151. The motor 540 can also be operatively connect to the stem 152 and/or the first outer body member 110. When the motor 540 is activated (e.g., by supplying electrical energy from the power source(s) 640 to it), the motor 540 can cause the platform 151 to rotate.

It will be appreciated that, in this arrangement, the rotation of the push structure 150 can occur independently of the morphing of the actuator 100. As such, the push structure 150 can be rotated before, during, or after the morphing of the actuator 100.

FIG. 5E shows a fifth example of an actuator with a push structure configured for rotation. In this example, the actuator 100 can include a threaded rod 550. One end of the threaded rod 550 can be operatively connected to the base 136 of the actuator 100. The end of the threaded rod 550 can be fixed to the base 136 while allowing rotation of the threaded rod 550. The other end of the threaded rod 550 can be fixed to the platform 151. Thus, the threaded rod 550 and the push structure 150 can rotate together. The threaded rod 550 can pass through an aperture in the first outer body member 110. However, the aperture can include teeth that interlocking engage with the threads of the threaded rod 550. Thus, when the actuator 100 is activated, the second dimension 195 of the actuator increases. Due to the interlocking engagement between the teeth and the threads, the morphing of the actuator 100 can cause the threaded rod to rotate, which causes the rotation of the platform 151.

It will be appreciated that, in this arrangement, the rotation of the push structure 150 can be dependent upon the morphing of the actuator 100. As such, the push structure 150 rotates simultaneously with the morphing of the actuator 100.

Referring to FIG. 6, an example of a system 600 for the actuator 100 with the rotatable push structure 150. The system 600 can include various elements. Some of the possible elements of the system 600 are shown in FIG. 6 and will now be described. It will be understood that it is not necessary for the system 600 to have all of the elements shown in FIG. 6 or described herein. The system 600 can have any combination of the various elements shown in FIG. 6. Further, the system 600 can have additional elements to those shown in FIG. 6. In some arrangements, the system 600 may not include one or more of the elements shown in FIG. 6. Further, the elements shown may be physically separated by large distances. Indeed, one or more of the elements can be located remote from the other elements of the system 600, such an on a remote server or cloud-based server.

In some arrangements, various elements of the system 600 may be located on or within a vehicle, it will be understood that one or more of these elements can be located external to the vehicle. Thus, such elements are not located on, within, or otherwise carried by the vehicle. In some arrangements, one or more elements of the system 600 can be located on or within a seat.

The system 600 can include one or more processors 610, one or more data stores 620, one or more sensors 630, one or more power sources 640, one or more input interfaces 650, one or more output interfaces 660, and/or one or more control modules 280. Each of these elements will be described in turn below.

As noted above, the system 600 can include one or more processors 610. “Processor” means any component or group of components that are configured to execute any of the processes described herein or any form of instructions to carry out such processes or cause such processes to be performed. The processor(s) 610 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 610 can include at least one hardware circuit (e.g., an integrated circuit) configured to carry out instructions contained in program code. In arrangements in which there is a plurality of processors 610, such processors can work independently from each other or one or more processors can work in combination with each other.

The system 600 can include one or more data stores 620 for storing one or more types of data. The data store(s) 620 can include volatile and/or non-volatile memory. Examples of suitable data stores 620 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 620 can be a component of the processor(s) 610, or the data store(s) 620 can be operatively connected to the processor(s) 610 for use thereby. The term “operatively connected,” as used throughout this description, can include direct or indirect connections, including connections without direct physical contact.

In some arrangements, the data store(s) 620 can store one or more actuation profiles. The actuation profiles can include instructions for activating one or more of the actuators 100 in a specified manner. The actuation profiles can include activation patterns, activation sequences, activation zones, activation regions, activation times, activation of individual actuators or groups of actuators, etc. The actuation profiles can be created by an end user, a seat manufacturer, a vehicle manufacturer, or some other entity. In some instances, one or more actuation profiles can be received from a remote source.

The system 600 can include one or more sensors 630. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 600 includes a plurality of sensors 630, the sensors can work independently from each other. Alternatively, two or more of the sensors can work in combination with each other. In such case, the two or more sensors can form a sensor network. The sensor(s) 630 can be operatively connected to the processor(s) 210, the data store(s) 620, and/or other elements of the system 600 (including any of the elements shown in FIG. 1). The sensor(s) 630 can include any suitable type of sensor, now known or later developed. For instance, when the system 600 is used in connection with a seat, the sensor(s) 630 can include one or more seat occupant sensors. The seat occupant sensor(s) can include one or more weight sensors, position sensors, proximity sensors, contact sensors, or any other sensor, now known or later developed, that can acquire data or information about a seat occupant or the seat relative to the seat occupant.

As noted above, the system 600 can include one or more power sources 640. The power source(s) 640 can be any power source capable of and/or configured to energize the actuator 100, as will be described later. For example, the power source(s) 640 can include one or more batteries, one or more fuel cells, one or more generators, one or more alternators, one or more solar cells, and combinations thereof. The power source(s) 640 can be any suitable source of electrical energy.

The system 600 can include one or more input interfaces 650. An “input interface” includes any device, component, system, element or arrangement or groups thereof that enable information/data to be entered into a machine. The input interface(s) 650 can receive an input from a vehicle occupant (e.g. a driver or a passenger). Any suitable input interface 650 can be used, including, for example, a keypad, gesture recognition interface, voice recognition interface, display, touch screen, multi-touch screen, button, joystick, mouse, trackball, microphone and/or combinations thereof.

The system 600 can include one or more output interfaces 660. An “output interface” includes any device, component, system, element or arrangement or groups thereof that enable information/data to be presented to a vehicle occupant (e.g. a person, a vehicle occupant, etc.). The output interface(s) 660 can present information/data to a vehicle occupant. The output interface(s) 660 can include a display. Alternatively or in addition, the output interface(s) 660 may include an earphone and/or speaker. Some components of the system 600 may serve as both a component of the input interface(s) 650 and a component of the output interface(s) 660.

The system 600 can include one or more modules, at least some of which will be described herein. The modules can be implemented as computer readable program code that, when executed by a processor, implements one or more of the various processes described herein. One or more of the modules can be a component of the processor(s) 610, or one or more of the modules can be executed on and/or distributed among other processing systems to which the processor(s) 610 is operatively connected. The modules can include instructions (e.g., program logic) executable by one or more processor(s) 210. Alternatively or in addition, one or more data stores 620 may contain such instructions. In some arrangements, the module(s) can be located remote from the other elements of the system 600.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 600 can include one or more control modules 670. The control module(s) 670 can include profiles and logic for controlling the actuator 100 or a plurality of the actuators 100. The control module(s) 670 can use profiles, parameters, or settings loaded into the control module(s) 670 and/or stored in the data store(s) 620, such as the actuation profiles. In some arrangements, the control module(s) 670 can be located remotely from the other elements of the system 600, such as on a remote server, a cloud-based server, or an edge server.

The control module(s) 670 can be configured to cause the actuator 100 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 670 can cause the actuator 100 to be selectively activated or deactivated in any suitable manner. For instance, when the actuator 100 include a shape memory material member, the shape memory material members can be heated by the Joule effect by passing electrical current through the shape memory material members. To that end, the control module(s) 670 can be configured to selectively permit, restrict, adjust, alter, and/or prevent the flow of electrical energy from the power source(s) 640 to the one or more shape memory material members of the actuator 100. The control module(s) 670 can be configured to send control signals or commands over the communication network 690 to the shape memory material members or to other elements of the system 600.

The control module(s) 670 can be configured to cause the actuator 100 to be activated or deactivated based on various events, conditions, inputs, or other factors. For instance, the control module(s) 670 can be configured to cause the actuator 100 to be activated or deactivated based on a user input. A user can provide an input on the input interface(s) 650. The input can be a command to activate actuator 100 and/or cause one or more push structures 150 to rotate.

In some arrangements, the control module(s) 670 can be configured to determine an appropriate action for the actuator 100 and/or the push structure 150. The control module(s) 670 can be configured to do so in any suitable manner. For instance, the control module(s) 670 can analyze data or information acquired by the sensor(s) 630 (e.g., the seat occupant sensor(s)) to detect when to activate the actuator 100 and/or cause the rotation of the push structure 150.

The various elements of the system 600 can be communicatively linked to one another or one or more other elements through one or more communication networks 690. As used herein, the term “communicatively linked” can include direct or indirect connections through a communication channel, bus, pathway or another component or system. A “communication network” means one or more components designed to transmit and/or receive information from one source to another. The data store(s) 620 and/or one or more other elements of the system 600 can include and/or execute suitable communication software, which enables the various elements to communicate with each other through the communication network and perform the functions disclosed herein.

The one or more communication networks 690 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

Now that the various potential systems, devices, elements and/or components of the actuator 100 and the system 600 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

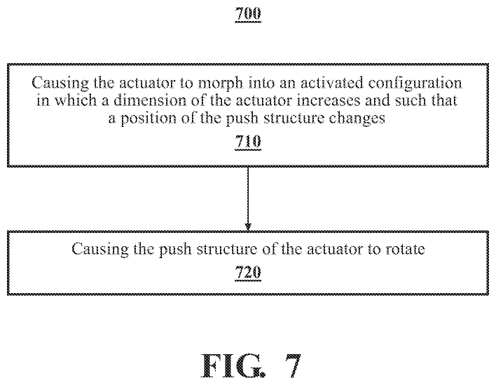

Turning to FIG. 7, an example of a method 700 of actuating an actuator with a rotatable push structure is shown. At block 710, the actuator 100 can be caused to morph into an activated configuration in which a dimension of the actuator 100 increases and such that a position of the push structure 150 changes. Such causing can be performed by the processor(s) 610 and/or the control module(s) 670. For instance, the processor(s) 610 and/or the control module(s) 670 can cause or allow the flow of electrical energy from the power sources(s) 640 to the actuator 100. In a particular example, the processor(s) 610 and/or the control module(s) 670 can cause or allow the flow of electrical energy from the power sources(s) 640 to the contracting member(s) 180 or the shape memory material member(s) 181 of the actuator 100. The dimension that increases can be the second dimension 195 (e.g., the height). The method 700 can continue to block 720.

At block 720, the push structure 150 can be caused to rotate. In some arrangements, such causing can be performed by the processor(s) 610 and/or the control module(s) 670. In one example, the processor(s) 610 and/or the control module(s) 670 can cause or allow the flow of electrical energy from the power sources(s) 640 to the motor(s) 540, as in the arrangement described in connection with FIG. 5D. In another example, the processor(s) 610 and/or the control module(s) 670 can cause or allow the flow of electrical energy from the power sources(s) 640 to the separate contracting member(s) or to the separate shape memory material member(s) 520, 181, as in the arrangement described in connection with FIG. 5C.

In some arrangements, such causing can occur as a result the actuator 100 morphs from one configuration to another configuration (e.g., from the non-activated configuration to the activated configuration, from the activated configuration to the non-activated configuration, or from one activated configuration to another activated configuration, etc.). Examples of such causing would occur in the arrangements described in connections with FIGS. 5A, 5B, and 5E.

In some arrangements, blocks 710 and 720 can occur substantially simultaneously. For instance, the rotation of the push structure 150 can occur as the actuator 100 morphs from one configuration to another configuration. In other arrangements, block 720 can occur before, during, and/or after block 710.

In some arrangements, the causing in block 720 can occur in response to a user input. For example, the processor(s) 610 and/or the control module(s) 670 can be configured to detect user inputs (e.g., commands) provided on the input interface(s) 650. In response, the processor(s) 610 and/or the control module(s) 670 can be configured to cause the rotation of the push structure 150. For instance, the processor(s) 610 and/or the control module(s) 670 can cause or allow the flow of electrical energy from the power sources(s) 640 to the motor(s) 540 or to the separate contracting members or the separate shape memory material members 520, 181.

The method 700 can end. Alternatively, the method 700 can return to block 710 or to some other block. The method 700 can be repeated at any suitable point, such as at a suitable time or upon the occurrence of any suitable event or condition.

Arrangements described herein can be used in various application. For instance, arrangements described herein can be used in connection with a seat. In such a case, one or more of the actuators 100 can be located within or operatively positioned relative to a seat. The seat can be any type of vehicle seat, now known or later developed. In one or more arrangements, the seat can be a vehicle seat. “Vehicle” means any form of transport, including motorized or powered transport. In one or more implementations, the vehicle can be an automobile, a watercraft, an aircraft, a hovercraft, a spacecraft, or any other form of transport. In other arrangements, the seat can be an office chair, a chair, a massage chair, a gaming chair, a recliner, or any other seat structure, now known or later developed.

In one or more arrangements, a plurality of actuators 100 can be operatively positioned relative to one or more surfaces or portions of the seat. The one or more surfaces can be a surface of the back portion, the seat portion, a bolster of the back portion, a bolster of the seat portion, a headrest, an arm rest, or any combination or subset thereof. When actuated, one or more of the actuators 100 can cause the surfaces or portions of the seat to morph into a different configuration and/or one or more of the actuators 100 can provide a physical sensation to an occupant of the seat. Likewise, the rotation of the push structure 150 can provide a physical sensation to an occupant of the seat.

In arrangements with a plurality of actuators, the plurality of actuators can be substantially identical to each other. Alternatively, one or more of the actuators can be different from the other actuators in one or more respects, such as size, shape, configuration, actuation effect, etc. The plurality of actuators can be arranged and/or distributed in any suitable manner. In some instances, the plurality of actuations can be arranged in rows and columns. In some instances, the plurality of actuators can be arranged in a plurality of discrete areas, which may or may not be spaced apart.

It will be appreciated that arrangements described herein can provide numerous benefits, including one or more of the benefits mentioned herein. For example, arrangements described herein can provide an enhanced experience for a seat occupant. Arrangements described herein can provide an enhanced massaging effect. When used in connection with a seat, arrangements described herein can provide a pushing effect to a seat occupant. In addition, arrangements described herein can provide a turning sensation.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. An actuator, comprising:
an outer body member; and
a push structure operatively connected to the outer body member, the push structure being configured to rotate,
when activated, the actuator is configured to morph into an activated configuration in which a dimension of the actuator increases and such that a position of the push structure changes.

2. The actuator of claim 1, wherein the push structure is configured to rotate independently of the morphing of the actuator.

3. The actuator of claim 1, wherein the rotation of the push structure is dependent upon the morphing of the actuator.

4. The actuator of claim 1, further including one or more contracting members, when an activation input is provided to the one or more contracting members, the one or more contracting members contract, thereby causing the actuator to morph into an activated configuration.

5. The actuator of claim 4, wherein the one or more contracting members are one or more shape memory material members.

6. The actuator of claim 4, further including one or more processors operatively connected to the one or more contracting members, whereby the one or more processors are configured to selectively activate the one or more contracting members, thereby causing the actuator to morph into the activated configuration.

7. The actuator of claim 6, further including one or more power sources operatively connected to supply electrical energy to the one or more contracting members, wherein the one or more processors are operatively connected to the one or more power sources, wherein the one or more processors are configured to selectively control a supply of electrical energy to the one or more contracting members.

8. The actuator of claim 6, further including one or more sensors configured to acquire sensor data, wherein the one or more sensors being operatively connected to the one or more processors, and wherein the one or more processors are configured to selectively cause the push structure to rotate based on sensor data acquired by the one or more sensors.

9. The actuator of claim 6, further including one or more user input interfaces, wherein the one or more user input interfaces are operatively connected to the one or more processors, and wherein the one or more processors are configured to selectively cause the push structure to rotate in response to an input provided on the one or more user input interfaces.

10. The actuator of claim 1, wherein the push structure is configured to rotate simultaneously with the morphing of the actuator.

11. The actuator of claim 1, wherein the push structure is configured to rotate after the actuator morphs into the activated configuration.

12. The actuator of claim 1, wherein the actuator further includes a spring loaded spindle operatively positioned between the push structure and the outer body member.

13. The actuator of claim 1, further including a shape memory material member being wrapped around an outer peripheral surface of the push structure, whereby, when activated, the shape memory material member contracts and causes the push structure to rotate.

14. The actuator of claim 1, further including a shape memory material member, wherein, when an activation input is provided to the shape memory material member, the shape memory material member contracts, thereby causing the actuator to morph into an activated configuration, wherein a portion of the shape memory material member is wrapped around an outer peripheral surface of the push structure, whereby, the contraction of the shape memory material member contracts causes the push structure to rotate.

15. The actuator of claim 1, wherein the actuator further includes a motor operatively connected to the push structure, and wherein rotation of the push structure is caused by activating the motor.

16. The actuator of claim 1, wherein the actuator further includes a threaded rod operatively connected to the push structure, wherein, when morphing of the actuator causes the threaded rod and the push structure to rotate.

17. A method for an actuator, the actuator including an outer body member, the actuator including a push structure operatively connected to the outer body member, the push structure being configured to rotate, the method comprising:
causing the actuator to morph into an activated configuration in which a dimension of the actuator increases and such that a position of the push structure changes; and
causing the push structure to rotate.

18. The method of claim 17, wherein the rotation of the push is independent of the morphing of the actuator.

19. The method of claim 17, wherein the rotation of the push structure is dependent upon the morphing of the actuator.

20. The method of claim 17, wherein the rotation of the push structure occurs simultaneously with the morphing of the actuator.
